(19) United States
(12) Patent Application Publication
(10) Pub. No.: US 2014/0153476 A1
(43) Pub. Date: Jun. 5, 2014

(54) METHOD AND APPARATUS FOR COUNTING MBMS SERVICE IN A MCE ARCHITECTURE

(71) Applicants: He Wang, Shanghai (CN); Philippe Godin, Velizy (FR)

(72) Inventors: He Wang, Shanghai (CN); Philippe Godin, Velizy (FR)

(73) Assignee: ALCATEL LUCENT, Paris (FR)

(21) Appl. No.: 14/233,511

(22) PCT Filed: Jul. 13, 2012
(86) PCT No.: PCT/IB2012/001450

§ 371 Date: Jan. 17, 2014

(30) Foreign Application Priority Data
Jul. 18, 2011 (CN) 201110201200.X

(51) Int. Cl. H04W 4/06

(52) U.S. Cl. CPC H04W 4/06
USPC 370/312

(57) ABSTRACT

A method and an apparatus for counting MBMS services in a network architecture of a distributed MCE is provided. In the method, a mobility management entity sends at least: one MBMS service UE counting request message to at least one eNB which belongs to a service area and is served by the mobility management entity, wherein the at least one eNB integrates a multicast coordination entity function respectively; receives at least one MBMS service UE counting response message from the at least one eNB, the at least one response message being used for feeding back to the mobility management entity respectively whether the MBMS service UE counting request message is correctly received: receives at least one MBMS service UE counting result report from at least one related eNB among the at least one eNB: determines whether to transmit at least: one MBMS service in a MBSFN mode is a specific MBSFN, according to the at least one MBMS service UE counting result report; sends a MBMS service session start message or a MBMS service session end message to a corresponding eNB according to the determining result.

### FIELD OF THE INVENTION

The present invention relates to a network architecture of a distributed multicast coordination entity, more particularly, to a method and an apparatus for counting UEs that are interested in a MBMS service or receiving a MBMS service in a network architecture of a distributed MCE.

### BACKGROUND OF THE INVENTION

Currently, 3GPP TS 36.300 has defined two kinds of eMBMS architectures, one is a centralized and independent MCE (multicast coordination entity), which is independent from an eNB and manages a plurality of eNBs that it serves, and the other is a distributed MCE integrated in an eNB, as illustrated in FIG. 1. The distributed MCE architecture is designed for the static and simple use of the eMBMS (evolved Multimedia Broadcast Multicast Service) service or temporary deployments of the eMBMS service at the first phase. The distributed MCE can accelerate the operator's deployment of the MBMS service in LTE. However, it usually cannot support dynamic and changeable MBMS service types and many dynamic and complex functions of scheduling, since the aim of the design is to accomplish the static and simple use. OAM (Operation and Maintenance) method is a common method for configuring the distributed MCE, such that the MCEs in different eNBs in one MBSFN (Multimedia Broadcast Single Frequency) will keep a consistent configuration, which is usually static. For example, an administrator can configure MCS (modulation and coding scheme) for the channels of mobile network television by the OAM method. However, with the progress of 3GPP, some new functions have been introduced in the eMBMS service, for example, counting function. The deployment of the present distributed MCE architecture cannot satisfy the realization of the function. Therefore, an optimization for the deployment scenario of the distributed MCE architecture is needed.

In Rel 10 eMBMS service, the counting function has been introduced for the MCE to control the MBSFN transmission of a certain MBMS service in a whole MBSFN area. That is, the MCE calculates the amount of UEs that are interested in one or more MBMS services or receiving the one or more MBMS services, so as to perform the MBSFN transmission control for a certain service. The counting is aimed at the services and is initiated by a network. Currently, the MCE is the start point of a counting request and the end point of a counting result, wherein the MCE collects the counting results from different eNBs. Then the MCE determines whether the MBSFN transmission should be performed for the service according to the result of the counting. Therefore, it is obvious, that the centralized MCE architecture can realized the centralized control and decision. The counting request is uniformly initiated by the centralized MCE. Then the counting results from different eNBs are collected by a centralized MCE, and the centralized MCE will make the uniform decision that whether the MBSFN transmission within the whole MBSFN area will be performed for this service.

However, for the distributed MCE architecture, there is no centralized MCE node used for initiating uniformly the counting request and collecting the counting results for making a decision, since the MCE function is located in each eNB. In a MBSFN area, each eNB has its own MCE function and there are a plurality of MCE function modules in a MBSFN area. Therefore, it is obvious, that there is no counting function in the distributed MCE architecture, and the counting function has not been considered in the design of such architecture. Therefore, in the distributed MCE architecture, the problems that how to realize the counting function, and how to determine whether the MBSFN transmission should be performed for a certain MBMS service according to the counting result are needed to be solved.

### SUMMARY OF THE INVENTION

According to a first aspect of the invention, it is provided a method, in a mobility management entity, for counting UEs that are interested in a MBMS service or receiving a MBMS service, the method comprising the steps of: sending at least one MBMS service UE counting request message to at least one eNB which belongs to a service area and is served by the mobility management entity, wherein each eNB integrates a multicast coordination entity function respectively; receiving at least one MBMS service UE counting response message from the at least one eNB, the at least one response message being used for feeding back to the mobility management entity respectively whether the at least one MBMS service UE counting request message is correctly received by the at least one eNB; receiving at least one MBMS service UE counting result report from the at least one eNB; determining whether to transmit at least one MBMS service in a MBSFN mode in a specific MBSFN, according to the at least one MBMS service UE counting result report; and sending a MBMS service session start message or a MBMS service session end message to a corresponding eNB according to the determining result.

According to a second aspect of the invention, it is provided a method, in an eNB, for reporting a MBMS service UE counting information to a serving mobility management entity of the eNB, wherein the eNB integrates a multicast coordination entity function, and the method comprises the steps of: receiving a MBMS service UE counting request message from the mobility management entity; sending at least one MBMS service UE counting request MCCH message to at least one UE served by the eNB to calculate the amount of UEs which are interested in the MBMS service or receiving the MBMS service; receiving at least one MBMS service UE counting result report message fed back by at least one related UE in the at least one UE, the at least one MBMS service UE counting result report message being used to report that the at least one related UE is interested in the MBMS service or receiving the MBMS service; calculating the amount of UEs which are interested in the MBMS service or receiving the MBMS service in a cell served by the eNB in a specific MBSFN, according to the at least one MBMS service UE counting result report message fed back by the related UE; reporting a calculating result as a MBMS service UE counting result report to the mobility management entity.

According to a third aspect of the invention, it is provided a method, in an eNB, for providing information to a superior mobility management entity of the eNB, wherein the eNB integrates a multicast coordination entity function, and the method comprises the steps of: sending an eNB service area configuration report message to the mobility management entity via a M3 interface, the eNB service area configuration report message including information of a service area that the eNB belongs to.

According to a fourth aspect of the invention, it is provided a first apparatus, in a mobility management entity, for counting UEs that are interested in a MBMS service or receiving a MBMS service, the first apparatus comprising:
a first sending device, for sending at least one MBMS service UE counting request message to at least one eNB which belongs to a service area and is served by the mobility management entity, wherein each eNB integrates a multicast coordination entity function respectively; a first receiving device, for receiving at least one MBMS service UE counting response message from the at least one eNB, the at least one response message being used for feeding back to the mobility management entity respectively whether the at least one MBMS service UE counting request message is correctly received by the at least one eNB; the first receiving device is further used for receiving at least one MBMS service UE counting result report from at least one related eNB among the at least one eNB; a determining device, for determining whether to transmit at least one MBMS service in a MBSFN mode in a specific MBSFN, according to the at least one MBMS service UE counting result report; and a processing device, for sending a MBMS service session start message or a MBMS service session end message to a corresponding eNB according to the determining result.

According to a fifth aspect of the invention, it is provided a second apparatus, in an eNB, for reporting a MBMS service UE counting information to a serving mobility management entity of the eNB, wherein the eNB integrates a multicast coordination entity function, and the second apparatus comprises: a second receiving device, for receiving a MBMS service UE counting request message from the mobility management entity; a second sending device, for sending at least one MBMS service UE counting request MCCH message to at least one UE served by the eNB to calculate the amount of UEs which are interested in the MBMS service or receiving the MBMS service; the second receiving device is further used for receiving at least one MBMS service UE counting result report message fed back by at least one related UE in the at least one UE, the at least one MBMS service UE counting result report message being used to report that the at least one related UE is interested in the MBMS service or receiving the MBMS service; a calculating device, for calculating the amount of UEs which are interested in the MBMS service or receiving the MBMS service in a cell served by the eNB in a specific MBSFN, according to the at least one MBMS service UE counting result report message fed back by the related UE; a reporting device, for reporting a calculating result as a MBMS service UE counting result report to the mobility management entity.

According to a sixth aspect of the invention, it is provided a third apparatus, in an eNB, for providing information to a superior mobility management entity of the eNB, wherein the eNB integrates a multicast coordination entity function, and the third apparatus comprises: a third sending device, for sending an eNB service area configuration report message to the mobility management entity via a M3 interface, the eNB service area configuration report message including information of a service area that the eNB belongs to.

With the solution of the present invention, the MME is responsible for the centralized control of the counting procedure, and the counting result is determined in a distributed MCE architecture as in a centralized stand alone MCE. Only a simple M3AP signaling procedures similar to a M2AP counting request and reporting procedure are added to the M3 interface. It avoids complexity of the distributed initialization gathering, counting request decision and result decision in the distributed architecture. It needs the additional function in a MME, so as to generate and initialize the counting request procedure, process the counting result and make a decision for the MBSFN transmission for the service according to the counting result and determine and schedule to send a session start message to an eNB.

### BRIEF DESCRIPTION OF DRAWINGS

With reference to the following detailed description of the non-restrictive embodiments, other features, objects and advantages of the present invention will be more apparent.

FIG. 1a shows a network schematic diagram of a centralized MCE architecture;

FIG. 1b shows a network schematic diagram of a distributed MCE architecture;

FIG. 2 shows a system method flowchart according to a detailed embodiment of the present invention;

FIG. 3 shows a service area configuration report procedure of an eNB designed according to a detailed embodiment of the present invention;

FIG. 4 shows an example M3AP signaling structure of a MBMS service UE counting result report message designed according to a detailed embodiment of the present invention;

FIG. 5 shows an apparatus diagram according to an embodiment of the present invention;

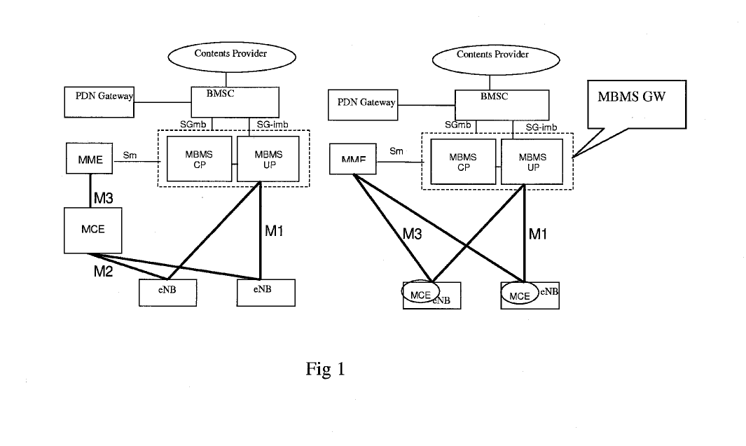

Wherein same or similar reference numerals refer to same or similar apparatuses (modules) or steps.

### DETAILED DESCRIPTION OF EMBODIMENTS

In the following, some terms in the present invention will be explained briefly at first.

MBSFN (Multimedia Broadcast Single Frequency Network): multi-cell transmission mode, in which MBMS data is transmitted simultaneously over the air interface of multiple tightly time-synchronized cells. A UE receives and combines the synchronization signals from multiple cells. In fact, provided that the transmissions from the multiple cells are sufficiently tightly synchronized for each to arrive at the UE within the cyclic prefix at the start of the symbol, the MBSFN transmission appears to a UE as a transmission from a single large cell, and the UE receiver may treat the multi-cell transmissions in the same way as multi-path components of a single-cell transmission.

MBSFN area refers to the area within which cells transmit the same contents, that is to say, performs MBSFN transmission, and a UE performs MBSFN combination. In a network, there may exist multiple MBSFN areas at the same time, and a MBMS service may be transmitted on multiple MBSFN areas. In the mean time, the system can also support the scenario in which multiple MBSFN areas are overlapped in a cell. A candidate cell for a UE handover to or cell reselection may belong to a MBSFN area different from the serving cell.

In principle one MBSFN area is controlled by one MCE. But for a distributed MCE deployment, each MCE in an eNB is only responsible for the radio resource control of the MBSFN transmission for this single eNB. The distributed MCE in an eNB is usually implemented by the method of OAM pre-configuration for the corresponding MBMS PRB (Physical Resource Block) parameters. All the eNBs within the same MBSFN area have the same MBMS PRB parameters pre-configuration. For the distributed MCE architecture, the M2 interface should be kept between the MCE and the corresponding eNB. It would be implemented as an internal interface of the eNB. In the following, the eNB will be set as the description object. It would be appreciated by those skilled in the art, that the MCE function is integrated in an eNB, since a distributed MCE deployment scenario is described in the present invention. The M3 interface described in the following is between the MME and MCE, that is to say, between the MME and the eNB.

It can be seen that the distributed MCE architecture can achieve the MBSFN transmission based on the fixed OAM pre-configuration and fixed mapping rules. However, this is difficult for the counting function which is more randomized and requires centralized controlling. Therefore, the applicant proposes to improve the MME (mobility management entity) function and the M3 interface so as to support the counting function.

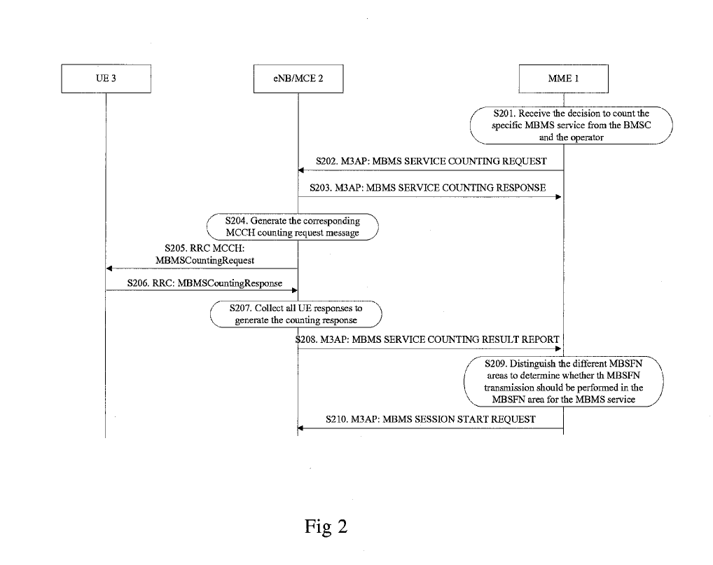

To centralized control the counting function in the distributed MCE architecture, the applicant move the centralized controlling and decision function to the network node MME which serves the MCE. Therefore, on the one hand, the counting procedure would be initiated by the MME which is unified to the eNBs within the whole SA (service area). SA is a concept of high layer application layer. Generally one SA corresponds to one service. When a MME manages multiple services, one MME includes multiple SAs correspondingly. On the other hand, the MME is responsible for collecting the counting result, and make the uniform decision for the MBSFN transmission of the service. The complete flowchart of the counting procedure conducted by the MME in the distributed MCE architecture is illustrated in FIG. 2. In this embodiment, we set the scenario before starting the session as the example to explain.

Firstly, in step S201, MME1 receives a MBMS session start request message from the BMSC (Broadcast Multicast Service Center) via the MBMS gateway. As the counting procedure for one service is decided by the operator, the operator can trigger the initiation of the counting procedure at the MME. This process is similar as triggering the counting request at the MCE. The operator may initiate by sending an OAM console command to the MME processing the counting request. Since the MME only knows the information of the service area, the counting request initiated by the MME would spread in the whole service area.

How the MME 1 gets the information of the service area and maps the information of the service area to the list of the eNBs could be achieved via the following two options:

Option 1: configured in the MME

At first, the MME may receive the list of TAs (tracking area) via a S1 interface from the eNBs. Therefore, the MME can know which eNBs are included in which TA. If a corresponding mapping between the SA and the list of TAs is configured in the MME, the mapping between the SA and the list of eNBs could be easily deduced by using these two previous sets of information.

Option 2: introducing the new M3AP procedure to enable the eNB to report the information of a service area of its controlled cell to the MME

Then, the MME may get the knowledge of mapping service area and the list of eNBs. This procedure needs to be processed at the initial stage of the eNB/MCE startup, which is similar to the M2 setup procedure in the M2 interface. Therefore, such procedure can be defined as a part of the content of the M3 setup. Here “eNB SA configuration report” procedure is just used as an example.

This new M3AP “eNB SA configuration report” procedure could be the class 1 or class 2 procedure.

TABLE 1
M3AP eNB SA Configuration Report procedures

| Elementary Procedure | Message |
|---|---|
| eNB SA Configuration Report | eNB SA CONFIGURATION REPORT |

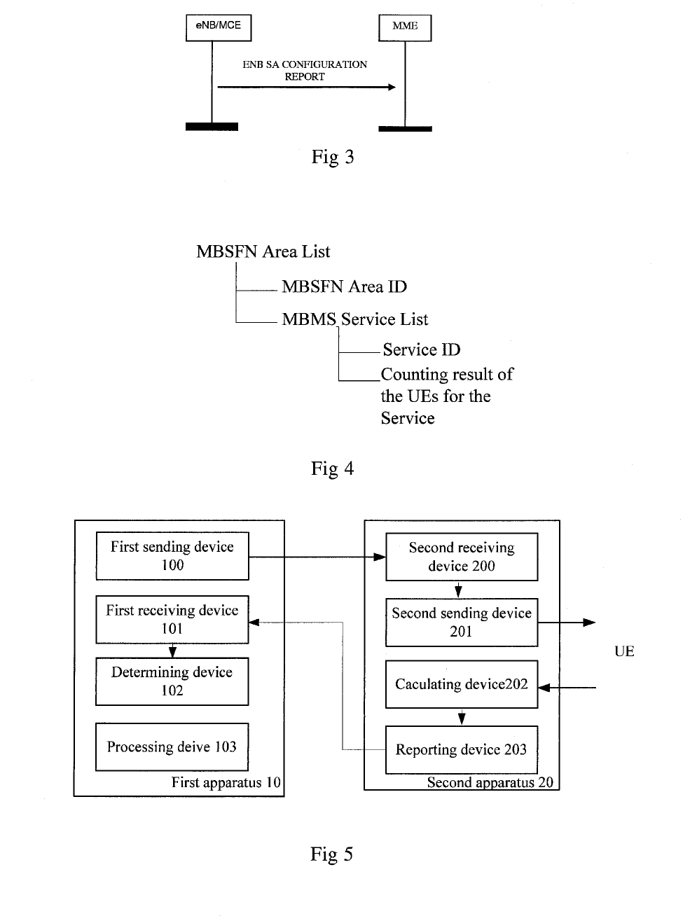

The basic signaling flowchart for the eNB SA configuration report procedure is illustrated as follows. The eNB initiates the procedure by sending the eNB SA configuration report message to the MME, the message including the information of a service area of the eNB controlled cells. FIG. 3 illustrates the signaling interaction procedure between the eNB and the MME.

The detailed signaling design of the eNB SA configuration report is listed as follows (Note: reference section refers to TS36.444 v10.1.0).

eNB SA CONFIGURATION REPORT

This message is sent by eNB/MCE to report information of a service area of its controlled cells.

Direction: eNB/MCE→MME

| | | | | IE type and | Semantics | | Assigned |
|---|---|---|---|---|---|---|---|
| IE/Group Name | | Presence | Range | reference | description | Criticality | Criticality |
| Message Type | | M | | 9.2.1.1 | | YES | reject |
| MCE MBMS M3AP ID | | M | | 9.2.3.1 | | YES | reject |
| SA Configuration | | | 1 to | | | EACH | reject |
| per cell | | | <maxnoofCells> | | | | |
| | >E-UTRAN | M | | 9.2.1.x | | YES | reject |
| | CGI | | | | | | |
| | >MBMS | | 1 to | | | | |
| | Service | | <maxnoofMBMSServiceAreasPerCell> | | | | |
| | Area Item | | | | | | |

| | | | | |
|---|---|---|---|---|
| >>MBMS | M | 9.2.3.6 | YES | reject |
| Service | | | | |
| Area | | | | |

Wherein IE/Group Name, Presence, Range, IE type and reference, Semantics description, Criticality and Assigned Criticality are known parameters in the art, therefore would not be described in detail herein.

| Range bound | Explanation |
|---|---|
| maxnoofCells | Maximum no. of cells that may be served by an |
| | eNB. The value for maxnoofCells is 256. |
| maxnoofMBMSServiceAreasPerCell | Maximum no. of Service Areas per cell. The value |
| | for maxnoofMBMSServiceAreasPerCell is 256. |

E-UTRAN (evolved universal terrestrial radio access network) CGI (cell group identity)

This information element is used to globally identify a cell (see TS 36.401)

| | | | | |
|---|---|---|---|---|
| IE/Group | Pres- | | IE type and | |
| Name | ence | Range | reference | Semantics description |

| | | | |
|---|---|---|---|
| PLMN | M | 9.2.3.7 | |
| Identity | | | |
| Cell | M | BIT | The 20 leftmost bits |
| Identity | | STRING | of the Cell Identity |
| | | (28) | correspond to the eNB |
| | | | ID. |

Then, in step S202, MME1 sends a MBMS service UE counting request (also represented as MBMS SERVICE COUNTING REQUEST) to the eNB2 which belongs to a specific service area and is served by MME 1.

In the M3 interface, a new procedure needs to be defined as “MBMS service counting”, which is Class 1 procedure and illustrated in Table 2.

TABLE 2
M3AP Class 1 procedure MBMS Service Counting

| | | Successful | Unsuccessful |
|---|---|---|---|
| | | Outcome | Outcome |
| Elementary | Initiating | Response | Response |
| Procedure | Message | message | message |
| MBMS | MBMS | MBMS | MBMS |
| Service | SERVICE | SERVICE | SERVICE |
| Counting | COUNTING | COUNTING | COUNTING |
| | REQUEST | RESPONSE | FAILURE |

Because the MBSFN area is the RAN (Radio Access Network) concept known by the MCE and the informed to the eNB2 via M2 setup procedure, MME 1 has no information of MBSFN area at the beginning. The eNB 2 with the MCE function has the MBSFN area information configured at the beginning. The counting function decision of the MBSFN transmission is aimed at each MBSFN area. But the MME 1 only has the information about the service area for one service. Therefore, at first, MME 1 sends the counting request to the whole service area.

Similar to the M2AP MBMS service counting request message, the M3AP MBMS service UE counting request message also needs to indicate the “MCCH Update Time” for the eNB 2 to broadcast the counting request unifiedly to the UE 3 on the air interface via the updated MCCH message at the same time. In order to achieve the MCCH update synchronization for the MBSFN transmission, the duration of modification period (MP) needs to be configured in the MME.

However, different from the M2AP MBMS service counting request, there would be no “MBSFN Area ID” in the message to indicate the MBSFN area in which this service is requested to be counted, since the MME 1 have no such information of the MBSFN area. Therefore, the counting request for the service is in the whole service area range.

Of course, similar to the M2AP MBMS service counting request, the MME 1 can request to count multiple services simultaneously in one M3AP MBMS service UE counting request message, but all these services need to have the same service area.

The detailed signaling design of the M3AP MBMS service UE counting request is listed as below:

(Note: reference section refers to TS36.444 v10.1.0)

MBMS Service UE Counting Request

This message is sent by the MME 1 to request the eNB 2 to report the amount of connected mode UEs that are receiving or interested in the MBMS service(s).

Direction: MME→eNB/MCE

| | | | | IE type and | Semantics | | Assigned |
|---|---|---|---|---|---|---|---|
| IE/Group Name | | Presence | Range | reference | description | Criticality | Criticality |
| Message Type | | M | | 9.2.1.1 | | YES | reject |
| MME MBMS M3AP ID | | M | | 9.2.3.2 | | YES | reject |
| MCCH Update Time | | M | | 9.2.1.x | | YES | reject |
| MBMS Counting | | M | | | | YES | reject |
| Request Session | | | | | | | |
| | >MBMS | | 1 to | | | EACH | reject |
| | Counting | | <maxnoofcountingservice> | | | | |
| | Request | | | | | | |
| | Session | | | | | | |
| | Item | | | | | | |

| | | | | |
|---|---|---|---|---|
| >>TMGI | M | 9.2.3.3 | — | — |

Wherein, TMGI represents Temporary Mobile Group Identity

| Range bound | Explanation |
|---|---|
| maxnoofcountingservice | Maximum no. of the services that |
| | are counted by RAN. The value for |
| | maxnoofcountingservice is 16. |

MCCH Update Time

| | | | | |
|---|---|---|---|---|
| IE/Group | Pres- | | IE type and | |
| Name | ence | Range | reference | Semantics description |

| | | | |
|---|---|---|---|
| MCCH | M | INTEGER | This IE indicates the modifi- |
| Update | | (0 . . . 255) | cation period, as an absolute |
| Time | | | value, from when the MCCH |
| | | | update should be applied. |
| | | | Note: The duration of the |
| | | | modification period is con- |
| | | | figured in eNB and MME. |

This information element indicates the time at which the eNB shall apply the updated of the MCCH as specified in TS 36.300.

Then, in step S203, eNB 2 sends a response message to the MME 1. Herein only eNB 2 is set as an example to be explained. However, it is appreciated by those skilled in the art, all the eNBs which have received MBMS service request messages need to feed the response message back to the MME, regardless of that the eNB serves UEs that are interested in a MBMS service or receiving a MBMS service or not. That is, MME 1 receives at least one MBMS service UE counting response message from the at least one eNB, the at least one response message being used for feeding back to the mobility management entity respectively whether the MBMS service UE counting request message is correctly received by the at least one eNB;

Specifically, once the corresponding eNB has correctly received MBMS service UE counting request in the M3 interface, the eNB will respond to the MME with the MBMS service UE counting response and prepare for the subsequent counting process.

The detailed signaling design of the M3AP MBMS service counting response is listed as below:

(Note: reference section refers to TS36.444 v10.1.0)

MBMS SERVICE COUNTING RESPONSE

This message is sent by the eNB/MCE to acknowledge the MBMS service counting request message.

Direction: eNB/MCE→MME

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.2.1.1 | YES | reject |
| MME MBMS M3AP ID | M | 9.2.3.2 | YES | reject |
| MCE MBMS M3AP ID | M | 9.2.3.1 | YES | reject |
| Criticality Diagnostics | O | 9.2.1.7 | YES | ignore |

If the eNB is not capable of correctly processing the MBMS service UE counting request from the MME, it shall return the MBMS service UE counting failure, to the MME.

The detailed signaling design of the M3AP MBMS service UE counting failure is listed as below:

(Note: reference section refers to TS36.444 v10.1.0)

MBMS SERVICE UE COUNTING FAILURE

This message is sent by the eNB/MCE to report the unsuccessful outcome of the request from the MBMS service UE counting request message.

Direction: eNB/MCE → MME.

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.2.1.1 | YES | reject |
| MME MBMS M3AP ID | M | 9.2.3.2 | YES | reject |
| Cause | M | 9.2.1.2 | YES | reject |
| Criticality | O | 9.2.1.7 | YES | ignore |
| Diagnostics | | | | |

Step S204 to Step S207 in FIG. 2 is similar as the counting procedure in the centralized stand-alone MCE architecture, the counting result is obtained by referring to the air interface interaction between the eNB and the UE.

Firstly, in step S204, eNB 2 generates the corresponding MCCH message according to the received counting request and according to the “MCCH Update Time” indication, to update the MCCH message broadcasted in the air interface.

In step S205, eNB 2 sends at least one MBMS service UE counting request MCCH message to at least one UE served by the eNB 2, that is, eNB 2 send the MCCH message to the UE via the air interface. The MCCH message is used to request the MBMS counting situation of the UE.

Then, in step S206, the related UE reports the MBMS service UE counting result report message to the eNB, to report that the related UE is interested in the MBMS service or is receiving the MBMS service.

Specifically, the UE which has received the MBMS service UE counting request MCCH message will firstly determine whether it is interested in this MBMS service or is receiving this MBMS service. If it is interested in this MBMS service or is receiving this MBMS service, the UE, for example UE 3, will feed the MBMS service UE counting result report message back to the eNB 2, the report message indicating the UE is interested in the MBMS service or is receiving the MBMS service.

Considering that the MBMS service UE counting request message received by the UE 3 from the eNB 2 may include multiple services, preferably, the MBMS service UE counting result report message reported by the UE 3 to the eNB 2 includes a list, the list including the service identifier of the MBMS services which the UE is interested in or is receiving. Of course, the above embodiment is only an example. In the actual network application, the form of the list is changeable.

Then, in step S207, the eNB 2 collects all the related UE response of the counting request. Then, the eNB 2 generates its own counting result report, according to the UE response which have the indication of in which MBSFN area the counting is requested and of which MBMS service that the UE is interested in or is receiving.

Then, in step 208, in the M3 interface, a new procedure is needed to be defined as “MBMS service counting result report”, which is a Class 2 procedure, that is, no-response procedure.

TABLE 3
MBMS Service Counting Result report

| Elementary Procedure | Message |
|---|---|
| MBMS Service Counting | MBMS SERVICE COUNTING |
| Result report | RESULT REPORT |

Similar to the M2AP MBMS service counting result report, the M3AP MBMS service counting result report also has the MBSFN area information that indicates which MBSFN area this eNB 2 belongs to. Otherwise for each MBSFN area, the MBMS service counting list, which indicates the counting result of each requested MBMS service, is contained. However, considering the multiple MBSFN areas overlapping instance and the simultaneous multiple services counting requests, the M3AP MBMS service counting result report could report the multiple MBMS services counting results in the multiple MBSFN areas in one message.

The MBMS service UE counting result report of the eNB 2 includes a MBSFN area list corresponding to the eNB 2, wherein each item of the list includes respective MBSFN area identifiers and corresponding MBMS service lists, and the MBMS service list includes respective MBMS service identifiers and corresponding UE counting results. The corresponding UE counting results include, for example, the amount of the UEs which are interested in the MBMS service or receiving the MBMS service, as illustrated in FIG. 4.

Although the MME sends the MBMS service UE counting request message to all the eNBs which belong to a service area and are served by the MME, it is appreciated by those skilled in the art, that it is possible that the eNB which belongs to a service area and is served by the MME does not serve UEs which are interested in the MBMS service or receiving the MBMS service. Therefore, it is not necessary for such eNB to report the MBMS service UE counting report message to the MME. Only the eNB serves UEs which are interested in the MBMS service or receiving the MBMS service, as the related eNB, reports the MBMS service UE counting result report message to the MME.

The detailed signaling design of the M3AP MBMS service counting result report is listed as below:

(Note: reference section refers to TS36.444 v10.1.0)

MBMS SERVICE COUNTING UE RESULT REPORT

This message is sent by the eNB/MCE to report the amount of connected mode UEs that are receiving or interested in the MBMS service(s) as indicated in the MBMS service counting result report message.

Direction: eNB/MCE→MME.

| | | | | | | |
|---|---|---|---|---|---|---|
| | | | IE type and | Semantics | | Assigned |
| IE/Group Name | Presence | Range | reference | description | Criticality | Criticality |

| | | | | | |
|---|---|---|---|---|---|
| Message Type | M | | 9.2.1.1 | YES | reject |
| MCE MBMS M3AP ID | M | | 9.2.3.1 | YES | reject |
| Results of MBSFN Area | M | | | YES | reject |
| List | | | | | |
| >MBSFN Area List | | 1 to | | | |
| | | <maxnoofMBSFNareas> | | | |
| >>MBSFN Area ID | M | | 9.2.1.x | YES | reject |
| >>MBMS Counting | M | | | YES | reject |
| Result List | | | | | |
| >>>MBMS Counting | | 1 to | | EACH | reject |
| Result Item | | <maxnoofcountingservice> | | | |
| >>>>TMGI | M | | 9.2.3.3 | — | |
| >>>>Counting Result | M | | 9.2.1.x | — | |

| Range bound | Explanation |
|---|---|
| maxnoofMBSFNareas | Maximum no. of MBSFN areas served |
| | by a single eNB. The value for |
| | maxnoofMBSFNareas is 256. |
| Maxnoofcountingservice | Maximum no. of the services that |
| | are counted by RAN. The value for |
| | maxnoofcountingservice is 16. |

MBSFN AREA ID

| | | | | |
|---|---|---|---|---|
| IE/Group | Pres- | | IE type and | |
| Name | ence | Range | reference | Semantics description |

| | | | |
|---|---|---|---|
| MBSFN | M | INTEGER | The same encoding as the |
| Area Id | | (0 . . . 255) | mbsfn-AreaId specified |
| | | | in TS 36.331. |
| Counting | M | INTEGER | This IE indicates the |
| Result | | (0 . . . 1023) | number of connected mode |
| | | | UEs that are receiving or |
| | | | interested in a MBMS |
| | | | service. The value 1023 |
| | | | is used if the UE number |
| | | | is equal to or more than |
| | | | 1023. |

Then, in step S209, the MME 1 collects the MBMS service UE counting result report message from the related eNB.

In this step, the MME 1 collects the counting results in each eNB report. From the counting results, the MME 1 can also know that which MBSFN area that the eNB belongs to and the counting results of the each counted service in each MBSFN area. By so doing, the MME can count the interesting/receiving UE amount for each counting request service according to the granularity of the MBSFN area. The MME 1 can learn the amount of the UEs which are interested in the service in each MBSFN area.

According to the counting decision algorithm, the MME 1 can make a decision whether the MBSFN transmission should be performed in the MBSFN area. Assuming a service area may comprise multiple MBSFN areas, the MME 1 can further determine to which MBSFN areas it will send the session start, or not send the session start.

Then, in step S210, the MME 1 may schedule the MBMS session start request to be sent to the appropriate eNB/MCEs on the M3 interface, so as to perform the MBSFN transmission, according to the decision of the counting results in step S209, because the MME 1 knows which MBSFN area the eNB belongs to and in which MBSFN area this service can be transmitted in the MBSFN mode.

Specifically, in an embodiment, when the amount of the UEs which require to receive a specific MBMS service, is above a first predetermined threshold, the eNB in the MBSFN area is indicated to transmit this specific MBMS service in the MBSFN mode.

The above embodiments describe that, before the session start, the MME determines whether the MBMS service should be transmitted in the MBSFN mode in the MBSFN area by calculating the amount of the UEs which are interested in the specific MBMS service in the specific MBSFN. In another embodiment, the above flowchart is also substantially suitable for the following situation, in which a MBMS service is in the transmission procedure and the operator initiates a counting request for this MBMS service, such that the service may be requested to end the session in a certain MBSFN area. The difference is that step S201 will be replaced by step S201′. In step S201′, the MME receives the OAM command from the operator to instruct the MME to perform the counting function, so as to determine whether to end the MBSFN transmission of the MBMS service. Then, the MME, eNB and UE perform the corresponding steps S202-S209 respectively. Then step S210 is replaced by step S210′. In step S210′, when the MME determines that the amount of the UEs which require or are receiving the specific MBMS service, is lower than a second predetermined threshold, the MME instructs the eNBs which are transmitting the specific MBMS service in the MBSFN mode in the MBSFN area, to stop transmitting the specific MBMS service in the MBSFN mode.

The first predetermined threshold and the second predetermined threshold in the above embodiment is only used as an example. It is appreciated by those skilled in the art, that those threshold are related to a detailed algorithm and the strategy of the operator in the MME and MCE, which is not the point of the present patent.

With the above solution, the MME is responsible for the centralized control of the counting procedure, and make a decision for the counting result in the distributed MCE architecture as in the centralized stand alone MCE. Only a simple M3AP signaling procedure similar to a M2AP counting request and reporting procedure is added to the M3 interface. The complexity of the distributed initialization convergence, the counting request decision and the result decision in the distributed architecture is avoided. Additional functions in the MME is needed to generate and initialize the counting request procedure, process the counting result and make a decision for the MBSFN transmission for the service according to the counting result and determine and schedule to send a session start message or a session end message to appropriate eNBs.

FIG. 5 shows an apparatus diagram according to an embodiment of the present invention. The first apparatus 10 is in a mobility management entity for counting UEs that are interested in a MBMS service or receiving a MBMS service. The first apparatus 10 comprises a first sending device 100, a first receiving device 101, a determining device 102 and a processing device 103. The second apparatus 20 is in an eNB, for reporting a MBMS service UE counting information to a serving mobility management entity of the eNB, wherein the eNB integrates a multicast coordination entity function, and the second apparatus 20 comprises a first sending device 200, a second sending device 201, a calculating device 202 and a reporting device 203.

At first, the first sending device 100 sends at least one MBMS service UE counting request message to at least one eNB which belongs to a service area and is served by the mobility management entity, wherein each eNB integrates a multicast coordination entity function respectively.

Then, the second receiving device 200 receives a MBMS service UE counting request message from the mobility management entity.

Then, the first receiving device 101 receives at least one MBMS service UE counting response message from the at least one eNB, the at least one response message being used for feeding back to the mobility management entity respectively whether the MBMS service UE counting request message is correctly received.

Then, the second sending device 201 sends at least one MBMS service UE counting request MCCH message to at least one UE served by the eNB to calculate the amount of UEs which are interested in the MBMS service or receiving the MBMS service.

Then, the second receiving device 200 receives at least one MBMS service UE counting result report message fed back by at least one related UE in the at least one UE, the at least one MBMS service UE counting result report message being used to report that the at least one related UE is interested in the MBMS service or receiving the MBMS service.

Then, the calculating device 202 calculates the amount of UEs which are interested in the MBMS service or receiving the MBMS service in a cell served by the eNB in a specific MBSFN, according to the at least one MBMS service UE counting result report message fed back by the relate UE.

Then, the reporting device 203 reports a calculating result as a MBMS service UE counting result report to the mobility management entity.

The first receiving device 101 is further used for receiving at least one MBMS service UE counting result report from at least one related eNB among the at least one eNB.

Then, the determining device 102 determines whether to transmit at least one MBMS service in a MBSFN mode in a specific MBSFN, according to the at least one MBMS service UE counting result report.

Then, the processing device 103 sends a MBMS service session start message or a MBMS service session end message to a corresponding eNB according to the determining result.

The above is the description of the embodiments of the present invention. However, the present invention is not limited to the specific system, device and detailed protocol. Those skilled in the art can make various variation or modification in the scope of the appended claims.

By reading the description, disclosed content and the appended claims, those skilled in the art can understand and implement other variations for the disclosed embodiments. In the claims, the term “comprise” will not preclude another element(s) or step(s), and the term “a/an” preceding an element will not preclude “a plurality of” such elements. In the present invention, the terms “first”, “second”, etc., will be only used to represent a name instead of any specific order. In the actual application of the present invention, a component can implement the functions of the multiple technical features referenced in the claims. Any references in the claims cannot be understood as the limit to the scope.

1. A method, in a mobility management entity, for counting UEs that are interested in a MBMS service or receiving a MBMS service, the method comprising:
sending at least one MBMS service UE counting request message to at least one eNB which belongs to a service area and is served by the mobility management entity, wherein each eNB integrates a multicast coordination entity function respectively;
receiving at least one MBMS service UE counting response message from the at least one eNB, the at least one response message being used for feeding back to the mobility management entity respectively whether the at least one MBMS service UE counting request message is correctly received by the at least one eNB;
receiving at least one MBMS service UE counting result report from at least one related eNB among the at least one eNB;
determining whether to transmit at least one MBMS service in a MBSFN mode in a specific MBSFN, according to the at least one MBMS service UE counting result report; and
sending a MBMS service session start message or a MBMS service session end message to a corresponding eNB according to the determining result.

2. A method according to claim 1, wherein the counting request message is required to be sent to the at least one eNB which belongs to the service area and is served by the mobility management entity, and before the sending at least one MBMS service UE counting request message to at least one eNB which belongs to a service area and is served by the mobility management entity, wherein each eNB integrates a multicast coordination entity function respectively, the method further comprises:
obtaining an eNB corresponding to the service area;
sending at least one MBMS service UE counting request message to at least one eNB which belongs to a service area and is served by the mobility management entity, wherein each eNB integrates a multicast coordination entity function respectively further comprises:
sending the MBMS service UE counting request message to the eNB corresponding to the service area and is served by the mobility management entity.

3. A method according to claim 2, wherein the obtaining comprises:
receiving an eNB service area configuration report message from the eNB via a M3 interface, the eNB service area configuration report message including information of a service area corresponding to a cell served by the eNB.

4. A method according to claim 1, wherein the MBMS service UE counting message includes a MCCH update instructing information used for instructing the at least one eNB to update a MCCH synchronously.

5. A method according to claim 1, wherein the MBMS service UE counting result report includes a MBSFN area list corresponding to the eNB, each item of the list including respective MBSFN area identifiers and corresponding MBMS service lists, the MBMS service list including respective MBMS service identifiers and corresponding UE counting results;
the determining whether to transmit at least one MBMS service in a MBSFN mode in a specific MBSFN, according to the at least one MBMS service UE counting result report further comprises:
calculating the amount of the UEs which require to receive a specific MBMS service, in a MBSFN area identified by respective MBSFN area identifier, according to the MBSFN area identifier;
the sending a MBMS service session start message or a MBMS service session end message to a corresponding eNB according to the determining result further comprises:
instructing an eNB in the MBSFN area to transmit the specific MBMS service in the MBSFN mode, when the amount of the UEs which require to receive the specific MBMS service, in the MBSFN area, is larger than a first predetermined threshold.

6. A method according to claim 1, wherein the MBMS service UE counting result report includes a MBSFN area list corresponding to the eNB, each item of the list including respective MBSFN area identifiers and corresponding MBMS service lists, the MBMS service list including respective MBMS service identifiers and corresponding UE counting results;
the determining whether to transmit at least one MBMS service in a MBSFN mode in a specific MBSFN, according to the at least one MBMS service UE counting result report further comprises:
calculating the amount of the UEs which require to receive a specific MBMS service or is receiving the specific MBMS service, in a MBSFN area identified by respective MBSFN identifier, according to the MBSFN area identifier;
the sending a MBMS service session start message or a MBMS service session end message to a corresponding eNB according to the determining result further comprises: instructing eNBs which are transmitting the specific MBMS service in the MBSFN mode in the MBSFN area, to stop transmitting the specific MBMS service in the MBSFN mode, when the amount of the UEs which require to receive the specific MBMS service or is receiving the specific MBMS service in the MBSFN area is lower than a second predetermined threshold.

7. A method, in an eNB, for reporting a MBMS service UE counting information to a serving mobility management entity of the eNB, wherein the eNB integrates a multicast coordination entity function, and the method comprises:
receiving a MBMS service UE counting request message from the mobility management entity;
sending at least one MBMS service UE counting request MCCH message to at least one UE served by the eNB to calculate the amount of UEs which are interested in the MBMS service or receiving the MBMS service;
receiving at least one MBMS service UE counting result report message fed back by at least one related UE in the at least one UE, the at least one MBMS service UE counting result report message being used to report that the at least one related UE is interested in the MBMS service or receiving the MBMS service;
calculating the amount of UEs which are interested in the MBMS service or receiving the MBMS service in a cell served by the eNB in a specific MBSFN, according to the at least one MBMS service UE counting result report message fed back by the related UE;
reporting a calculating result as a MBMS service UE counting result report to the mobility management entity.

8. A method according to claim 7, wherein before the receiving a MBMS service UE counting request message from the mobility management entity, the method further comprises:
sending an eNB service area configuration report message to the mobility management entity via a M3 interface, the eNB service area configuration report message including information of a service area that the eNB belongs to.

9. A method according to claim 8, wherein the MBMS service UE counting result report includes a MBSFN area list corresponding to the eNB, each item of the list including respective MBSFN area identifiers and corresponding MBMS service lists, the MBMS service list including respective MBMS service identifiers and corresponding UE counting results.

10. A method, in an eNB, for providing information to a superior mobility management entity of the eNB, wherein the eNB integrates a multicast coordination entity function, and the method comprises:
sending an eNB service area configuration report message to the mobility management entity via a M3 interface, the eNB service area configuration report message including information of a service area that the eNB belongs to.

11. A first apparatus, in a mobility management entity, for counting UEs that are interested in a MBMS service or receiving a MBMS service, the first apparatus comprising:
a first sending device, for sending at least one MBMS service UE counting request message to at least one eNB which belongs to a service area and is served by the mobility management entity, wherein each eNB integrates a multicast coordination entity function respectively;
a first receiving device, for receiving at least one MBMS service UE counting response message from the at least one eNB, the at least one response message being used for feeding back to the mobility management entity respectively whether the at least one MBMS service UE counting request message is correctly received by the at least one eNB;
the first receiving device is further used for receiving at least one MBMS service UE counting result report from at least one related eNB among the at least one eNB;
a determining device, for determining whether to transmit at least one MBMS service in a MBSFN mode in a specific MBSFN, according to the at least one MBMS service UE counting result report; and
a processing device, for sending a MBMS service session start message or a MBMS service session end message to a corresponding eNB according to the determining result.

12. A first apparatus of claim 11, wherein the counting request message is required to be sent to the at least one eNB which belongs to the service area and is served by the mobility management entity, the first apparatus further comprising:
an obtaining device, for obtaining eNB information corresponding to the service area;
the first sending device is further used to sending the MBMS service UE counting request message to the eNB corresponding to the service area and is served by the mobility management entity.

13. A first apparatus of claim 11, wherein the MBMS service UE counting message includes a MCCH update instructing information used for instructing the at least one eNB to update a MCCH synchronously.

14. A second apparatus, in an eNB, for reporting a MBMS service UE counting information to a serving mobility management entity of the eNB, wherein the eNB integrates a multicast coordination entity function, and the second apparatus comprises:
a second receiving device, for receiving a MBMS service UE counting request message from the mobility management entity;
a second sending device, for sending at least one MBMS service UE counting request MCCH message to at least one UE served by the eNB to calculate the amount of UEs which are interested in the MBMS service or receiving the MBMS service;
the second receiving device is further used for receiving at least one MBMS service UE counting result report message fed back by at least one related UE in the at least one UE, the at least one MBMS service UE counting result report message being used to report that the at least one related UE is interested in the MBMS service or receiving the MBMS service;
a calculating device, for calculating the amount of UEs which are interested in the MBMS service or receiving the MBMS service in a cell served by the eNB in a specific MBSFN, according to the at least one MBMS service UE counting result report message fed back by the related UE;
a reporting device, for reporting a calculating result as a MBMS service UE counting result report to the mobility management entity.

15. A third apparatus, in an eNB, for providing information to a superior mobility management entity of the eNB, wherein the eNB integrates a multicast coordination entity function, and the third apparatus comprises:
a third sending device, for sending an eNB service area configuration report message to the mobility management entity via a M3 interface, the eNB service area configuration report message including information of a service area that the eNB belongs to.
